(19) United States
(12) Patent Application Publication
(10) Pub. No.: US 2026/0268204 A1
(43) Pub. Date: Sep. 10, 2026

(54) GPU TOPOLOGY MANAGEMENT

(71) Applicant: American Megatrends International, LLC, Duluth, GA (US)

(72) Inventors: Chitrak Gupta, Johns Creek, GA (US); Varadachari Sudan Ayanam, Suwanee, GA (US)

(21) Appl. No.: 19/070,950

(22) Filed: Mar. 5, 2025

(51) Int. Cl. G06N 20/00

(52) U.S. Cl. CPC G06N 20/00

(57) ABSTRACT

In an aspect of the disclosure, a method, a computer-readable medium, and a computer system are provided. The computer system includes one or more computing devices. The one or more computing devices receive, at a baseboard management controller (BMC), a request to modify a topology configuration of a plurality of graphics processing units (GPUs). The one or more computing devices transmit the request from the BMC to an inband module executing on a host operating system. The one or more computing devices determine, by the inband module, whether any processes are currently executing on the plurality of GPUs. The one or more computing devices implement the requested topology configuration modification using a vendor-specific library corresponding to a GPU family of the plurality of GPUs when no processes are currently executing.

### BACKGROUND

### Field

The present disclosure relates generally to computer systems, and more particularly, to techniques of managing GPU topology configurations in heterogeneous GPU environments through a unified interface that bridges baseboard management controller (BMC) operations with host-based GPU management tools.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

In modern AI data centers, Graphics Processing Units (GPUs) have become essential components for machine learning and artificial intelligence workloads. Data centers may deploy GPUs from multiple vendors, including NVIDIA, AMD, and Intel, each implementing their own proprietary interconnect technologies. NVIDIA uses NVLINK, AMD employs Infinity Fabric, and Intel utilizes RDMA over Converged Ethernet for managing communications between multiple GPUs. These vendor-specific approaches have created a complex landscape where data center operators must manage different tools and interfaces for each GPU vendor's technology.

Further, server management may be handled through out-of-band management interfaces provided by Baseboard Management Controllers (BMCs) using standard protocols such as IPMI, PLDM, and Redfish. These protocols allow administrators to monitor and control various server components remotely. However, BMCs have significant limitations when it comes to managing GPU topology and interconnections, particularly in systems where multiple GPUs are connected through switching architectures or fabric-based distributions. The BMC's out-of-band nature prevents it from directly accessing vendor-specific GPU drivers and libraries that operate at the host operating system level.

Each GPU vendor provides its own set of management tools and utilities for configuring GPU topology and collective communication parameters. Vendor-specific tools operate independently and require different command sets and approaches for similar management tasks. For distributed training operations, each vendor also implements its own collective communication library—NCCL for NVIDIA, RCCL for AMD, and oneCCL for Intel. This fragmentation has made it challenging for data center operators to implement consistent management practices across heterogeneous GPU environments, often requiring them to maintain multiple management workflows and tools for different GPU vendors.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a computer system are provided. The computer system includes one or more computing devices. The one or more computing devices receive, at a baseboard management controller (BMC), a request to modify a topology configuration of a plurality of graphics processing units (GPUs). The one or more computing devices transmit the request from the BMC to an inband module executing on a host operating system. The one or more computing devices determine, by the inband module, whether any processes are currently executing on the plurality of GPUs. The one or more computing devices implement the requested topology configuration modification using a vendor-specific library corresponding to a GPU family of the plurality of GPUs when no processes are currently executing.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller (BMC) and a host computer.

FIG. 2 is a matrix representation illustrating the interconnection topology of eight Graphics Processing Units within a system.

FIG. 3 is a diagram illustrating a system architecture for managing GPU topology in a heterogeneous GPU environment.

FIG. 4 is a flowchart illustrating a process for managing GPU topology changes while maintaining system stability and preventing disruption of active training processes.

FIG. 5 is a flow chart illustrating a method for managing GPU topology configurations.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

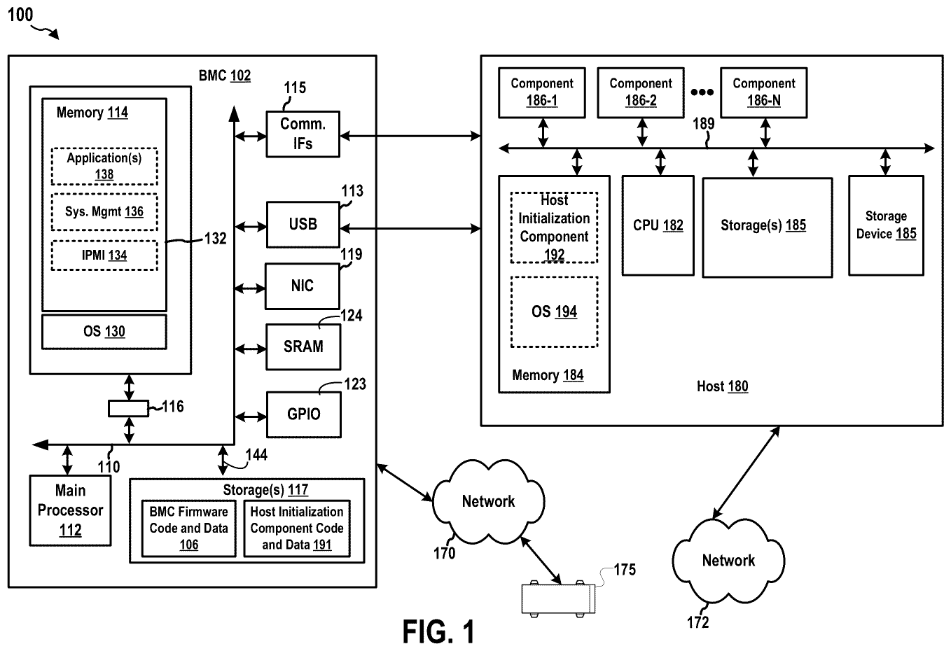

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January, 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170. Further, the storage(s) 117 is in communication with the communication channel 110 through a communication link 144.

In modern artificial intelligence (AI) data centers, the deployment of varying Graphics Processing Units (GPUs) from multiple vendors like Nvidia, AMD, and Intel presents a significant challenge due to the diversity of their respective methods for managing GPU topologies. Nvidia employs NVLINK, AMD utilizes the Infinity Fabric, and Intel uses RDMA over Converged Ethernet. This diversity complicates the efficient management and integration of these technologies, as each vendor's topology management requires distinct approaches.

Traditional methods, such as out-of-band management facilitated by the Baseboard Management Controller (BMC), primarily use standards like PLDM and IPMI to manage server infrastructure. However, these methods have limitations when it comes to controlling and configuring the interconnections and topologies of heterogeneous GPU components dynamically. For instance, in systems where multiple GPUs are interconnected over network switch architectures or where fabric-based distributions, like AMD's Infinity Fabric, are involved, the BMC, operating with its inherent out-of-band limitations, cannot alter the configuration parameters of these distributed systems directly. This limitation becomes pronounced when initializing or altering the topology setup for machine learning training operations, where specific GPU groupings and communication protocols are crucial for performance optimization.

For example, the computer system 100 may include multiple graphics processing units (GPUs) as part of the component devices 186-1 to 186-N. In AI and machine learning applications, these GPUs perform parallel processing tasks during model training operations, where mathematical computations are distributed across multiple GPUs to process large datasets and adjust model parameters iteratively. Different GPU vendors, including NVIDIA, AMD, and Intel, implement distinct interconnect technologies for managing communications between multiple GPUs. For instance, NVIDIA employs NVLINK, AMD utilizes Infinity Fabric, and Intel implements RDMA over Converged Ethernet.

The BMC 102, while capable of basic GPU monitoring through protocols such as PLDM and IPMI, cannot directly modify the GPU topology configurations or control the inter-GPU communication parameters during training operations. This limitation exists because GPU topology management requires direct access to vendor-specific drivers and libraries that operate at the host operating system level through the OS 194.

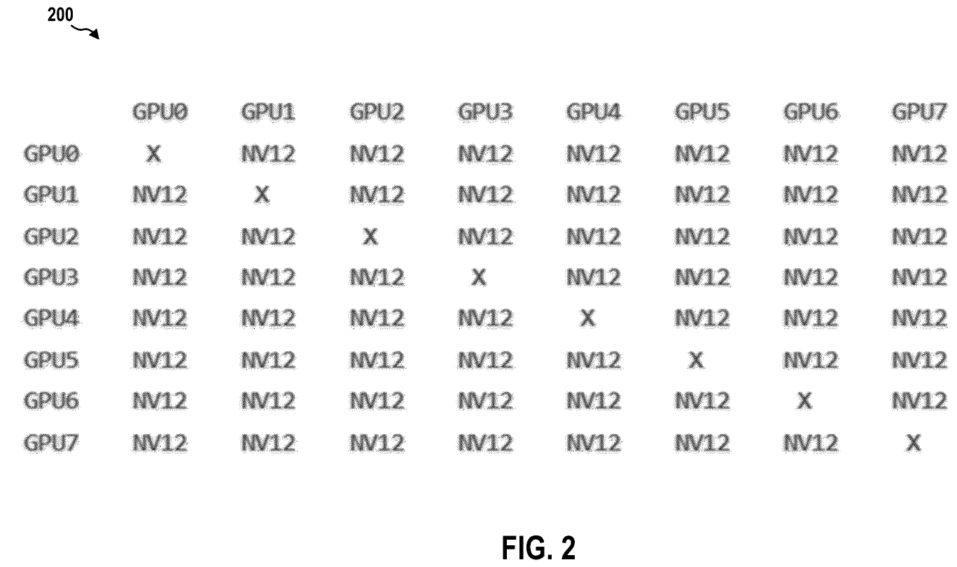

FIG. 2 is a matrix 200 representation illustrating the interconnection topology of eight Graphics Processing Units (GPUs) within a system, specifically showing the output of the nvidia-smi topo -m command for an NVIDIA H100 system. The rows and columns of the matrix are labeled GPU0 through GPU7, representing eight individual GPUs. The entries within the matrix indicate the type of connection between any two GPUs.

In this matrix, “X” denotes the connection of a GPU to itself, which is not a relevant connection for inter-GPU communication. The entry “NV12” signifies that the connection between the corresponding row and column GPUs is established via NVLink, specifically indicating 12 NVLink connections. For instance, GPU0 and GPU1 are connected via NV12 (12 NVLink connections), as are GPU0 and GPU2, and so on. This indicates a fully connected NVLink topology among all eight GPUs.

The nvidia-smi tool is a command-line utility provided by NVIDIA for managing and monitoring NVIDIA GPUs. The topo -m command specifically displays the GPU topology, revealing how GPUs are interconnected. Furthermore, nvidia-smi allows for the grouping of GPUs using the topo -s command, which is for configuring collective communication operations. For example, the command nvidia-smi topo -s 0,1,2,3,4,5,6,7 -b 0000,0000,0000,0000,1111,1111,1111,1111 would group GPUs 0-3 into one group and GPUs 4-7 into another. This grouping is used for optimizing distributed training tasks in AI workloads.

Different GPU vendors provide their own tools for topology management. AMD provides the rocm-smi tool, while Intel offers the hl-smi tool. Each of these tools interacts with the vendor's specific collective communication library (CCL), such as NVIDIA's NCCL, AMD's RCCL, and Intel's oneCCL. These CCLs are fundamental for managing the communication patterns and algorithms used during distributed training across multiple GPUs.

The challenge of managing these heterogeneous GPU environments may be addressed by providing a unified, in-band management interface that abstracts the complexities of interacting with different vendor-specific tools and CCLs. The Baseboard Management Controller (BMC) 102, as illustrated in FIG. 1, cannot directly modify this GPU topology, necessitating the in-band, host-based approach proposed by the invention. The BMC's limitations in directly affecting GPU interconnections, particularly in switched or fabric-based topologies, highlight the need for a host-based solution to manage fine-grained control over GPU communications and groupings.

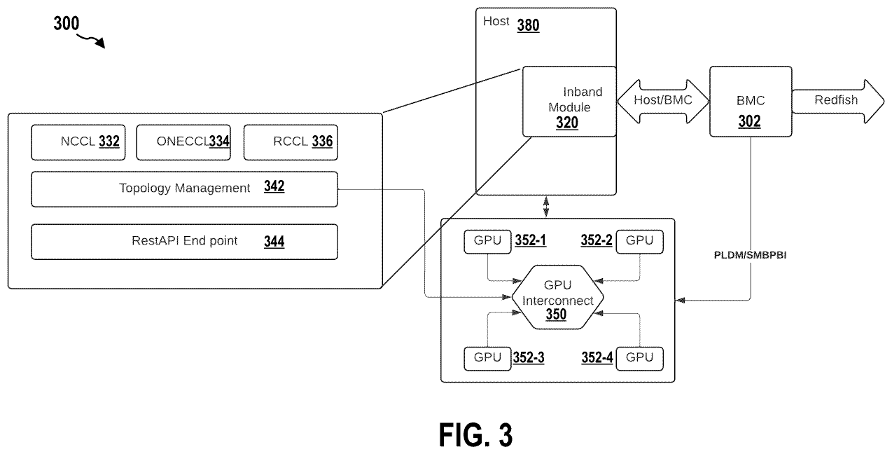

FIG. 3 is a diagram 300 illustrating a system architecture for managing GPU topology in a heterogeneous GPU environment. The architecture includes a BMC 302, a host 380, and multiple GPUs 352-1, 352-2, 352-3, and 352-4 interconnected through a GPU interconnect 350.

The host 380 executes an inband module 320 that provides a unified interface for managing GPU topology across different GPU vendors. The inband module 320 includes multiple collective communication libraries, specifically NCCL 332 for NVIDIA GPUs, ONECCL 334 for Intel GPUs, and RCCL 336 for AMD GPUs. These libraries enable communication between GPUs from their respective vendors during distributed computing operations.

A topology management component 342 within the inband module 320 orchestrates the configuration of GPU interconnections and groupings. The topology management component 342 interfaces with a RestAPI endpoint 344 that exposes management APIs through which topology configurations can be modified. The RestAPI endpoint 344 provides methods such as /cloud_platform/gpumanagement/SetTopology and /cloud_platform/gpumanagement/ChangeCCL to configure GPU topology and collective communication parameters.

The BMC 302 serves as a broker between external management interfaces and the inband module 320. The BMC 302 exposes Redfish APIs that external systems can use to initiate topology changes. When the BMC 302 receives a Redfish request to modify GPU topology, it communicates with the inband module 320 through a Host/BMC interface. The inband module 320 then uses the appropriate collective communication library (NCCL 332, ONECCL 334, or RCCL 336) based on the GPU family to implement the requested topology changes through the GPU interconnect 350.

This architecture addresses the challenge of managing heterogeneous GPU environments by providing an abstraction layer that standardizes topology management across different GPU vendors. The inband module 320 can execute on the host operating system because it requires access to vendor-specific GPU drivers that are not accessible through traditional out-of-band management interfaces. The BMC 302 maintains its role as the primary management interface while delegating GPU-specific operations to the inband module 320, thereby preserving existing management workflows while adding support for advanced GPU topology management.

The GPU interconnect 350 represents the physical interconnection fabric between the GPUs 352-1, 352-2, 352-3, and 352-4, which may use different technologies such as NVIDIA's NVLink, AMD's Infinity Fabric, or Intel's RDMA over Converged Ethernet, depending on the GPU vendor. The inband module 320 abstracts these vendor-specific interconnect technologies, allowing administrators to manage GPU topology without directly dealing with the underlying interconnect implementations.

As described supra, through the RestAPI end point 344, an administrator or an external orchestration service can specify how many GPUs are grouped for a given operation, such as arranging two GPUs in one group and six GPUs in another.

Whenever a request is received—by way of a Redfish API call issued from the BMC 302—the BMC 302 relays this request to the inband module 320 on the host 380. The inband module 320 identifies the vendor family of each target GPU and invokes the corresponding library calls in the NCCL 332, the ONECCL 334, or the RCCL 336. This step reconfigures communication paths through the GPU interconnect 350, thus affecting how data is routed between GPU nodes. When topology adjustments are made, the inband module 320 takes into account any ongoing processes or distributed training jobs that may be running on the GPUs; it checks for active processes and waits for a safe interval before issuing the reconfiguration to avoid interrupting critical computations.

The host 380 manages composition services through the inband module 320, which enables dynamic partitioning of GPU resources. For instance, for a batch-training job that only requires a subset of available GPU capacity, the BMC 302 may receive commands via Redfish to instruct the topology management component 342 to form an isolated cluster of two GPUs for testing or validation. At the same time, the remaining six GPUs may be allocated to another task. By implementing a service that resides partly on the BMC 302 and partly in the inband module 320, administrators can modify GPU interconnect settings and collective communication parameters from a single high-level interface.

This architecture further addresses limitations of out-of-band management approaches, which generally cannot configure switched or fabric-based interconnection topologies among GPUs. Instead, the inband module 320 interacts with drivers and utilities that individually manage each GPU's specialized interconnect hardware. In this manner, the BMC 302 remains the centralized point of management, while the host 380 carries out reconfiguration commands in an automated manner. As a result, a system designer is able to adjust resource configurations for various AI or machine learning workloads and efficiently distribute processing tasks across heterogeneous GPU families without having to switch between vendor-specific utilities or conflicting low-level interfaces.

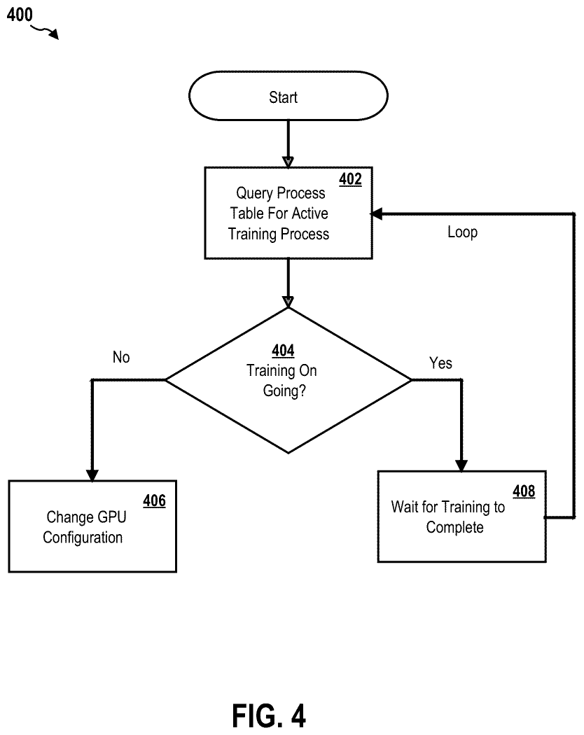

FIG. 4 is a flowchart 400 illustrating a process for managing GPU topology changes while maintaining system stability and preventing disruption of active training processes. The flowchart 400 demonstrates the decision-making logic implemented by the inband module 320 when handling requests for GPU topology modifications.

After start, in operation 402, the inband module 320 queries a process table of the host operating system to identify any active training processes running on GPUs such as the GPUs 352-1, 352-2, 352-3, and 352-4. This operation is necessary because modifying GPU topology or collective communication parameters during an active training session can lead to system instability, data corruption, or training failure.

In operation 404, the inband module 320 evaluates whether any training processes are currently executing. If a training process is detected, the process flows to operation 408, where the inband module 320 enters a wait state until the current training process completes. This waiting period prevents potential system crashes or data inconsistencies that could occur if topology changes were attempted during active training sessions. Alternatively, the identified active training processes may be force stopped as requested by a user. The process then loops back to operation 402 to recheck the process table.

If no training processes are detected in operation 404, the process proceeds to operation 406, where the inband module 320 executes the requested GPU configuration changes. These changes may include modifying the topology through the GPU interconnect 350, adjusting collective communication parameters via the appropriate library (NCCL 332, ONECCL 334, or RCCL 336), or reconfiguring GPU groupings for distributed training tasks.

More specifically, the inband module 320 implements process monitoring and topology management capabilities to maintain system stability during GPU configuration changes. The collective communication libraries—NCCL 332, ONECCL 334, and RCCL 336—serve as essential components for configuring GPU distributed training algorithms. These libraries interface with common AI frameworks such as PyTorch and TensorFlow, which utilize integrated CCL/Message Passing Interface (MPI) libraries to control training processes through their distributed modules. These frameworks can configure the training process, and, for example, torch.distributed modules in PyTorch provide APIs to control the process. The configuration of GPU topology directly impacts how these frameworks distribute and synchronize computations across multiple GPUs.

When the topology management component 342 receives a request to modify GPU configurations, it employs an approach that prevents system disruptions. The process begins with the inband module 320 examining the host operating system's process table to detect any active training processes on the GPUs 352-1, 352-2, 352-3, and 352-4. This examination is necessary because distributed training jobs exhibit high sensitivity to changes in communication patterns. Modifications to topology or collective communication parameters during active training can result in system deadlocks, data inconsistencies, or complete system failure.

The topology management component 342 implements a validation framework to verify the stability and performance of new configurations. After implementing topology changes through the GPU interconnect 350, the inband module 320 can execute minimalist training sets to evaluate the impact of the modifications. These test executions measure various performance metrics, including training speed, scalability, and convergence characteristics of the distributed training operations.

The cloud platform infrastructure augments this capability by providing a standardized testing environment. Through the RestAPI endpoint 344, administrators can deploy customer-specific training sets to validate configuration changes before implementing them in production environments. This testing framework operates in conjunction with the BMC 302, which serves as a communication broker between external management interfaces and the inband module 320.

The system architecture supports dynamic reconfiguration of GPU communication patterns while maintaining operational stability. When the topology management component 342 determines that no training processes are active, it can safely execute requested changes to the GPU configuration. These modifications may include adjusting the collective communication parameters through the appropriate vendor-specific library or reconfiguring GPU groupings for optimized distributed training operations.

In certain embodiments, GPU topology management is exposed to external systems through a Redfish resource that describes the existing configuration of multiple GPUs and the actions that can be invoked to modify this configuration. An example JSON representation of such a resource is shown below, where a GPUTopologyManager object provides relevant properties and actions:

```
{
    “@odata.context”:
“/redfish/v1/$metadata#GPUTopologyManager.GPUTopologyManager”,
    “@odata.id”: “/redfish/v1/GPUTopologyManager”,
    “@odata.type”:
“#GPUTopologyManager.v1_0_0.GPUTopologyManager”,
    “Id”: “GPUTopologyManager”,
    “Name”: “GPU Topology Manager”,
    “Description”: “Manager for configuring GPU topology”,
    “GPUs”: [
    {
      “GPUID”: “GPU1”,
      “Connections”: [
      {
        “TargetGPUID”: “GPU2”,
        “LinkType”: “NVLink”,
        “LinkSpeed”: 25
      },
      {
        “TargetGPUID”: “GPU3”,
        “LinkType”: “PCIe”,
        “LinkSpeed”: 16
      }
      ]
    },
    {
      “GPUID”: “GPU2”,
      “Connections”: [
      {
        “TargetGPUID”: “GPU1”,
        “LinkType”: “NVLink”,
        “LinkSpeed”: 25
      },
      {
        “TargetGPUID”: “GPU4”,
        “LinkType”: “NVLink”,
        “LinkSpeed”: 25
      }
      ]
    },
    {
      “GPUID”: “GPU3”,
      “Connections”: [
      {
        “TargetGPUID”: “GPU1”,
        “LinkType”: “PCIe”,
        “LinkSpeed”: 16
      },
      {
        “TargetGPUID”: “GPU4”,
        “LinkType”: “PCIe”,
        “LinkSpeed”: 16
      }
      ]
    },
    {
      “GPUID”: “GPU4”,
      “Connections”: [
      {
        “TargetGPUID”: “GPU2”,
        “LinkType”: “NVLink”,
        “LinkSpeed”: 25
      },
      {
        “TargetGPUID”: “GPU3”,
        “LinkType”: “PCIe”,
        “LinkSpeed”: 16
      }
      ]
    }
    ],
    “Actions”: {
      “#GPUTopologyManager.SetGPUTopology”: {
        “target”:
“/redfish/v1/GPUTopologyManager/Actions/GPUTopologyManager.SetGP
UTopology”,
        “title”: “Set GPU Topology”,
        “description”: “Configures the GPU topology by specifying the
connections between GPUs”
      }
    },
    “Oem”: { }
  }
```

In this representation, the GPUs property describes the available GPUs in the system. Each GPU is identified by a unique GPUID and contains a Connections array specifying communication links to other GPUs. Each connection object provides details such as the target GPU identifier (TargetGPUID), the communication medium (LinkType), and the link bandwidth or speed (LinkSpeed in GB/s). Such a structure allows an administrator or orchestration software to obtain a detailed view of the existing GPU interconnections, including whether those links are NVIDIA NVLink or PCIe connections.

The system introduces the capability to modify this GPU topology in a vendor-agnostic way through the SetGPUTopology action. This action is shown in the Actions property under #GPUTopologyManager.SetGPUTopology. In certain implementations, the BMC 302 presents this Redfish-based interface to external components and then relays topology modification requests to the inband module 320 on the host 380. The inband module 320 subsequently consults vendor-specific libraries, such as the NCCL 332 for NVIDIA, the RCCL 336 for AMD, or the ONECCL 334 for Intel, to enact the new topology via the GPU interconnect 350. Because the inband module 320 depends on host-level tools and drivers, the BMC 302 acts as an intermediary that preserves a common interface while the host 380 carries out the actual topology adjustments.

In one example, the firmware provider defines a REST API within the inband module 320, such as /cloud_platform/gpumanagement/SetTopology(gpuFamily, DesiredTopology, errorHandle), which corresponds to the Redfish action in the JSON structure above. A Redfish OEM action is utilized. This method bridges the gap between proprietary GPU configuration utilities and a uniform interface presented to data center orchestration stacks. By abstracting vendor-specific commands behind a consistent Redfish interface, administrators can modify GPU groupings or communication protocols from a single management endpoint before initiating or after completing a machine-learning training task.

This design also allows the cloud platform or other orchestration services to interact with the BMC 302 using Redfish, request topology adjustments, and receive confirmations or error messages without direct interaction with the vendor-specific software. The inband module 320 remains responsible for verifying that no active distributed training processes are running, as described referring to FIG. 4, and proceeds with requested changes only when the GPUs are not executing time-sensitive workloads.

More specifically, in this example, the BMC 302 exposes a Redfish schema that provides a standardized interface for managing GPU topology configurations. The schema defines a GPUTopologyManager resource that represents the current state and capabilities of the GPU topology management system. This resource includes detailed information about the available GPUs and their interconnections, presented in a structured format that follows the Redfish specification.

The BMC 302 implements this schema by acting as a broker between external management requests and the inband module 320. When a client sends a Redfish request to modify the GPU topology, the request is directed to the GPUTopologyManager endpoint at “/redfish/v1/GPUTopologyManager”. The GPUTopologyManager resource includes an Actions property that defines the available operations, particularly the SetGPUTopology action, which allows administrators to reconfigure the connections between GPUs.

The SetGPUTopology action, accessible through “/redfish/v1/GPUTopologyManager/Actions/GPUTopologyManager.SetGPUTopology”, serves as a standardized interface for initiating topology changes. When this action is invoked, the BMC 302 translates the Redfish request into corresponding calls to the inband module 320's RestAPI endpoint 344, specifically targeting the “/cloud_platform/gpumanagement/SetTopology” method with parameters including the gpuFamily, DesiredTopology, and errorHandle.

This implementation standardizes GPU topology management across heterogeneous environments. While the Data Center Manageability Task Force (DCMTF) has not established standards for GPU topology management, this schema provides a vendor-neutral method for controlling proprietary GPU interconnect technologies. The BMC 302's role as a broker allows it to maintain compatibility with existing Redfish-based management workflows while delegating the actual topology modifications to the host-based inband module 320.

The GPUTopologyManager schema supports the representation of complex GPU interconnect configurations. For example, in a system with four GPUs connected through both NVLink and PCIe interfaces, the schema can accurately represent the mixed connectivity topology. A GPU might have a high-speed NVLink connection to one neighbor (e.g., 25 GB/s) while maintaining PCIe connections to other GPUs (e.g., 16 GB/s), as demonstrated in the provided schema example where GPU1 connects to GPU2 via NVLink and to GPU3 via PCIe.

Through this Redfish implementation, the system provides a unified interface for managing GPU topologies across different vendor platforms, abstracting the complexities of vendor-specific tools such as nvidia-smi, rocm-smi, and hl-smi. The schema's structure allows for future extensibility to accommodate new GPU interconnect technologies and topology configurations as they emerge in the evolving landscape of AI data centers.

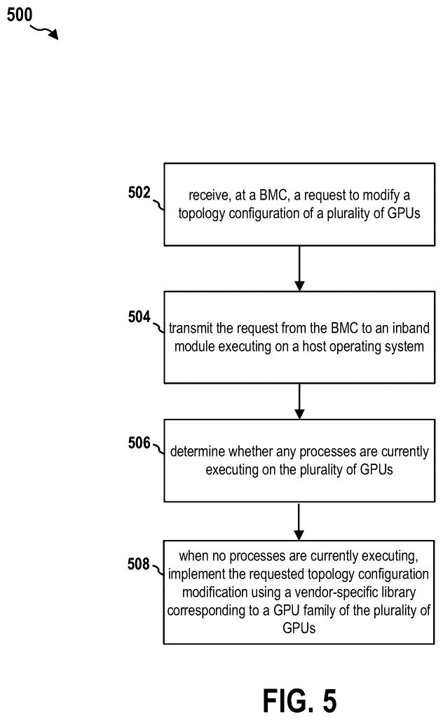

FIG. 5 is a flow chart 500 of a method for managing GPU topology configurations. The method may be performed by one or more computing devices (e.g., the BMC 102 and host 380). In operation 502, the one or more computing devices receive, at a baseboard management controller (BMC), a request to modify a topology configuration of a plurality of graphics processing units (GPUs). In operation 504, the one or more computing devices transmit the request from the BMC to an inband module executing on a host operating system. In operation 506, the one or more computing devices determine whether any processes are currently executing on the plurality of GPUs. In operation 508, when no processes are currently executing, the one or more computing devices implement the requested topology configuration modification using a vendor-specific library corresponding to a GPU family of the plurality of GPUs.

To determine whether any processes are currently executing, the one or more computing devices query a process table of the host operating system to identify active training processes running on the plurality of GPUs and wait for completion of any identified active training processes or force stop the identified active training processes as requested by a user before implementing the requested topology configuration modification.

The vendor-specific library is selected from a group consisting of NCCL (NVIDIA Collective Communications Library), RCCL (ROCm Collective Communications Library), and ONECCL (OneAPI Collective Communications Library) based on the GPU family.

To receive the request, the BMC exposes a Redfish application programming interface (API) and translates the request received via the Redfish API into a corresponding call to a RestAPI endpoint of the inband module. The request comprises receiving a Redfish action call to a GPU topology manager endpoint exposed by the BMC and extracting topology modification parameters from the Redfish action call.

After implementing the requested topology configuration modification, the one or more computing devices execute a test training set to validate performance of the modified topology configuration. The one or more computing devices monitor system performance metrics after implementing the topology configuration modification and generate a validation report indicating whether the modified topology configuration meets predetermined performance criteria.

To implement the requested topology configuration modification, the one or more computing devices group the plurality of GPUs into two or more groups for parallel processing tasks and configure collective communication parameters between GPUs within each group. The one or more computing devices identify vendor-specific GPU drivers installed on the host operating system, select appropriate collective communication libraries based on the identified GPU drivers, and configure GPU interconnections using the selected collective communication libraries. The one or more computing devices configure GPU interconnect switches to establish specified communication paths between GPUs according to the requested topology configuration and verify successful establishment of the communication paths before reporting completion of the modification.

The request to modify the topology configuration includes parameters specifying a GPU family identifier, a desired topology configuration, and an error handle for reporting configuration status.

The inband module maintains a representation of current GPU interconnections including connection types and link speeds between the plurality of GPUs. In certain configurations, the connection types include NVLink and PCIe connections, and the representation includes respective link speeds for each connection.

The inband module abstracts vendor-specific topology management commands behind a unified API interface accessible through the BMC.

The one or more computing devices receive, at the BMC, a request to modify collective communication parameters for distributed training operations, verify no active training processes are executing, and implement the modified collective communication parameters through the inband module.

The computing devices and components shown in FIGS. 2-5 may be implemented by the computer system 100 shown in FIG. 1. Specifically, the BMC 102 may implement the BMC 302 functionality for brokering GPU topology management requests, while the host computer 180 may implement the host 380 functionality including executing the inband module 320. The component devices 186-1 to 186-N of the host computer 180 may include the GPUs 352-1 through 352-4 that are interconnected via the GPU interconnect 350. The matrix 200 shown in FIG. 2 represents an example topology configuration that may be managed by the inband module executing on the host computer 180 in coordination with the BMC 102.

The process flow shown in FIG. 4 may be implemented by the host computer 180 and BMC 102, where the inband module executing on the host OS 194 queries the process table to check for active training processes before implementing topology changes requested through the BMC 102. The BMC 102 may expose the Redfish schema and APIs described in the technical description to allow external management of the GPU topology configuration through standardized interfaces, while delegating the actual topology modifications to the host-based inband module that has access to the vendor-specific GPU drivers and libraries installed on the host OS 194.

It is understood that the specific order or hierarchy of blocks in the processes /flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, comprising:
receiving, at a baseboard management controller (BMC), a request to modify a topology configuration of a plurality of graphics processing units (GPUs);
transmitting the request from the BMC to an inband module executing on a host operating system;
determining, by the inband module, whether any processes are currently executing on the plurality of GPUs; and
when no processes are currently executing, implementing the requested topology configuration modification using a vendor-specific library corresponding to a GPU family of the plurality of GPUs.

2. The method of claim 1, wherein the vendor-specific library is selected from a group consisting of NCCL (NVIDIA Collective Communications Library), RCCL (ROCm Collective Communications Library), and ONECCL (OneAPI Collective Communications Library) based on the GPU family.

3. The method of claim 1, further comprising:
exposing, by the BMC, a Redfish application programming interface (API) for receiving the request to modify the topology configuration; and
translating, by the BMC, the request received via the Redfish API into a corresponding call to a RestAPI endpoint of the inband module.

4. The method of claim 1, wherein determining whether any processes are currently executing comprises:
querying a process table of the host operating system to identify active training processes running on the plurality of GPUs; and
waiting for completion of any identified active training processes or force stopping the identified active training processes as requested by a user before implementing the requested topology configuration modification.

5. The method of claim 1, further comprising:
after implementing the requested topology configuration modification, executing a test training set to validate performance of the modified topology configuration.

6. The method of claim 1, wherein implementing the requested topology configuration modification comprises:
grouping the plurality of GPUs into two or more groups for parallel processing tasks; and
configuring collective communication parameters between GPUs within each group.

7. The method of claim 1, wherein the request to modify the topology configuration includes parameters specifying:
a GPU family identifier;
a desired topology configuration; and
an error handle for reporting configuration status.

8. The method of claim 1, further comprising:
maintaining, by the inband module, a representation of current GPU interconnections including connection types and link speeds between the plurality of GPUs.

9. The method of claim 8, wherein the connection types include NVLink and PCIe connections, and wherein the representation includes respective link speeds for each connection.

10. The method of claim 1, wherein implementing the requested topology configuration modification comprises:
identifying vendor-specific GPU drivers installed on the host operating system;
selecting appropriate collective communication libraries based on the identified GPU drivers; and
configuring GPU interconnections using the selected collective communication libraries.

11. The method of claim 1, further comprising:
receiving, at the BMC, a request to modify collective communication parameters for distributed training operations;
verifying no active training processes are executing or force stopping active training processes as requested by a user; and
implementing the modified collective communication parameters through the inband module.

12. The method of claim 1, wherein the inband module abstracts vendor-specific topology management commands behind a unified API interface accessible through the BMC.

13. The method of claim 1, further comprising:
monitoring, by the inband module, system performance metrics after implementing the topology configuration modification; and
generating a validation report indicating whether the modified topology configuration meets predetermined performance criteria.

14. The method of claim 1, wherein receiving the request comprises:
receiving a Redfish action call to a GPU topology manager endpoint exposed by the BMC; and
extracting topology modification parameters from the Redfish action call.

15. The method of claim 1, wherein implementing the requested topology configuration modification comprises:
configuring GPU interconnect switches to establish specified communication paths between GPUs according to the requested topology configuration; and
verifying successful establishment of the communication paths before reporting completion of the modification.

16. A system, including one or more computing devices, comprising:
a memory; and
at least one processor coupled to the memory and configured to:
receive, at a baseboard management controller (BMC), a request to modify a topology configuration of a plurality of graphics processing units (GPUs);
transmit the request from the BMC to an inband module executing on a host operating system;
determine, by the inband module, whether any processes are currently executing on the plurality of GPUs; and
when no processes are currently executing, implement the requested topology configuration modification using a vendor-specific library corresponding to a GPU family of the plurality of GPUs.

17. The system of claim 16, wherein the vendor-specific library is selected from a group consisting of NCCL (NVIDIA Collective Communications Library), RCCL (ROCm Collective Communications Library), and ONECCL (OneAPI Collective Communications Library) based on the GPU family.

18. The system of claim 16, wherein the at least one processor is further configured to:
expose, by the BMC, a Redfish application programming interface (API) for receiving the request to modify the topology configuration; and
translate, by the BMC, the request received via the Redfish API into a corresponding call to a RestAPI endpoint of the inband module.

19. The system of claim 16, wherein to determine whether any processes are currently executing, the at least one processor is configured to:
query a process table of the host operating system to identify active training processes running on the plurality of GPUs; and
wait for completion of any identified active training processes or force stop the identified active training processes as requested by a user before implementing the requested topology configuration modification.

20. A non-transitory computer-readable medium storing computer executable code for operating one or more computing devices, comprising code to:
receive, at a baseboard management controller (BMC), a request to modify a topology configuration of a plurality of graphics processing units (GPUs);
transmit the request from the BMC to an inband module executing on a host operating system;
determine, by the inband module, whether any processes are currently executing on the plurality of GPUs; and
when no processes are currently executing, implement the requested topology configuration modification using a vendor-specific library corresponding to a GPU family of the plurality of GPUs.
